(19) United States
(12) Patent Application Publication
(10) Pub. No.: US 2017/0265514 A1
(43) Pub. Date: Sep. 21, 2017

(54) Pellet-Coated Food Product and Method of Making

(71) Applicant: Frito-Lay North America, Inc., Plano, TX (US)

(72) Inventor: Joshua Scott Rivner, McKinney, TX (US)

(21) Appl. No.: 15/074,571

(22) Filed: Mar. 18, 2016

(51) Int. Cl. A23P 20/10; A23L 3/36

(52) U.S. Cl. CPC A23P 20/10; A23L 3/36; A23V 2002/00

(57) ABSTRACT

A pellet-coated food product and method of making the food product. In a first aspect, the invention provides a method comprising the steps: extruding an extruder feed stream to provide an extrudate; pelletizing the extrudate to provide extruded pellets; drying the pellets to provide dried pellets; providing at least a portion of an outer surface of a substrate with an adhesive to provide an adhesive substrate; applying at least a portion of the pellets to the outer surface of the substrate to provide a pellet-coated food product comprising the substrate and the pellets; and freezing the food product. In a second aspect, the invention provides a frozen, pellet-coated food product. The food product comprises a substrate comprising an outer surface and a substrate coating adhered to the outer surface of the substrate. The substrate coating comprises pellets, for example unexpanded pellets.

### BACKGROUND

Technical Field

The present invention relates to pellet-coated food products.

Background

Existing food products have limited coating options with respect to appearance, texture and taste. Furthermore, innovation in this field has been fairly stagnant. For example, breading has been used as a coating for fried and baked products, but the basic appearance, texture, and tastes provided by breading have not changed for some time.

### SUMMARY OF THE INVENTION

In a first aspect, the invention provides a method comprising the steps: extruding an extruder feed stream to provide an extrudate; pelletizing the extrudate to provide extruded pellets; drying the pellets to provide dried pellets; providing at least a portion of an outer surface of a substrate with an adhesive to provide an adhesive substrate; applying at least a portion of the pellets to the outer surface of the substrate to provide a pellet-coated food product comprising the substrate and the pellets; and freezing the food product.

In a second aspect, the present invention provides a frozen, pellet-coated food product. The food product comprises a substrate comprising an outer surface and a substrate coating adhered to the outer surface of the substrate. The substrate coating comprises pellets, for example unexpanded pellets.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic block flow diagram illustrating a method for producing a pellet-coated food product.

FIG. 2 is a schematic flow chart illustrating a method for producing a pellet-coated food product.

FIG. 3 is a schematic illustration of a pellet-coated food product.

FIG. 4 is a schematic illustration of a flat pellet.

FIG. 5 is a schematic illustration of pellets that have been ground to a relatively smaller size.

FIG. 6 is a schematic illustration of pellets that have been ground to a relatively moderate size.

FIG. 7 is a schematic illustration of pellets that have been ground to a relatively larger size.

FIG. 8 is a schematic illustration of an uncooked food product comprising a substrate that has been coated with the relatively smaller-sized pellets of FIG. 5.

FIG. 9 is a schematic illustration of an uncooked food product comprising a substrate that has been coated with the relatively moderate-sized pellets of FIG. 6.

FIG. 10 is a schematic illustration of an uncooked food product substrate that has been coated with relatively larger-sized pellets, for example, the pellets of FIG. 7.

FIG. 11 is a schematic illustration of an uncooked, non-pellet-coated substrate.

FIG. 12 is a schematic illustration of a cooked food product formed by cooking the food product of FIG. 8.

FIG. 13 is a schematic illustration of a cooked food product formed by cooking the food product of FIG. 9.

FIG. 14 is a schematic illustration of a cooked food product formed by cooking the food product of FIG. 10.

FIG. 15 is a schematic illustration of a cooked pellet-coated substrate comprising relatively larger-sized pellets.

FIG. 16 is a gray-scale photograph of pellets corresponding to the pellets of FIG. 5 that have been ground to a relatively smaller size.

FIG. 17 is a gray-scale photograph of pellets corresponding to the pellets of FIG. 6 that have been ground to a relatively moderate size.

FIG. 18 is a gray-scale photograph of pellets corresponding to the pellets of FIG. 7 that have been ground to a relatively larger size.

FIG. 19 is a gray-scale photograph of an uncooked food product comprising a substrate that has been coated with the relatively smaller-sized pellets of FIG. 16.

FIG. 20 is a gray-scale photograph of an uncooked food product comprising a substrate that has been coated with the relatively moderate-sized pellets of FIG. 17.

FIG. 21 is a gray-scale photograph of an uncooked food product substrate that has been coated with the relatively larger-sized pellets of FIG. 18.

FIG. 22 is a gray-scale photograph of a cooked food product formed by cooking the food product of FIG. 19.

FIG. 23 is a gray-scale photograph of a cooked food product formed by cooking the food product of FIG. 20.

FIG. 24 is a gray-scale photograph of a cooked food product formed by cooking a potato ball substrate that has been coated with ground bacon pellets.

FIG. 25 is a gray-scale photograph of a cooked food product that is essentially the same as the food product of 24, except the pellets are unground.

FIG. 26 is a gray-scale photograph of a cooked food product formed by cooking a food product coated with pellets that have been ground to a relatively larger size, for example, as illustrated in FIG. 18 and FIG. 21.

FIG. 27 is a gray-scale photograph of extruded, wavy, unground, uncooked chips.

FIG. 28 is a gray-scale photograph of pellets formed from extruded, wavy, ground, uncooked chips.

FIG. 29 is a gray-scale photograph of extruded, wavy, unground, cooked chips that have expanded so that some of the chips have a generally curved shape.

FIG. 30 is a gray-scale photograph of larger-sized pellets formed from extruded, ground, uncooked chips.

FIG. 31 is a gray-scale photograph of a food product comprising a mashed potato ball substrate coated with some of the pellets illustrated in FIG. 30 and also coated with an egg wash.

FIG. 32 is a gray-scale photograph of food products comprising a mashed potato ball substrate that was coated with some of the pellets of FIG. 30, next coated with an egg wash, and then cooked.

FIG. 33 is a gray-scale photograph of a food product comprising a mashed potato ball substrate that was coated with relatively smaller-sized pellets and then fried.

### DETAILED DESCRIPTION

The inventors have developed a new coating for food products that, in some embodiments, can provide novel appearances, textures, tastes and experiences for consumers. The new coating comprises pellets and can be used in conjunction with or in place of breading materials such as bread crumbs, cracker crumbs, chip-crumble, puffed rice, Japanese crumble, or panko crumble.

For example, in some embodiments, the new coating can provide the appearance, taste, and/or texture of a chip crumble (e.g., potato chip or tortilla chip). This is advantageous because chip-crumbles made directly from chips can have problems including inadequate adhesion, breakage caused by processing with breading equipment, and shelf-life problems. For example, the adhesion problem can be caused by the irregular shapes of the particles in a chip-crumble, which, in turn, can occur as a coating-application process breaks chips into different particle sizes. Meanwhile, the shelf-life problems can occur when a product substrate has a higher water activity than the chip-crumble. This causes water to migrate to the lower-water-activity chips and causes the chips to get soggy, lose desirable crunchiness, and/or otherwise become spoiled sooner than desirable. As another illustration, when uncooked, the pellets can provide a longer shelf-life relative to the shelf-life, for example, of cooked (e.g., fried) chips. Among other contributing factors, shelf-life can be reduced by the presence of oil, which can be oxidized and lead to less desirable product characteristics (e.g., off-tastes) or even spoilage. Furthermore, the differences in shelf-life can be profound. For example, in some embodiments, it is expected that a shelf-life of at least a year can be achieved for a product coated with uncooked pellets given appropriate packaging. Meanwhile, if the same product in the same packaging were coated with cooked chips, it would be limited by the shelf-life of the chips, which would be as little as a month but generally less than 3 months, for example, depending on the standards established to determine the shelf-life and the sensitivity of the standards to off-tastes caused by oxidation. Similar problems to those discussed herein can also occur with puffed grain (e.g., rice grains that have been expanded under vacuum to provide puffed-rice).

In contrast, a breading-like, cracker-like, chip-crumble-like, puffed-grain-like, Japanese-crumble-like, or panko-crumble-like coating made from pellets (e.g., unexpanded, unpuffed, and/or uncooked pellets) can be denser before final-cooking, be sturdier, and/or capable of remaining intact after a coating-application step (e.g., in a tumbler, breading machine, for example, a waterfall type breading machine, etc.). However, after cooking it can be less dense, more delicate (e.g., airy and/or crispy). As another advantages, these pellets can also have a sufficiently high water activity when applied to a substrate to help avoid water migration from the substrate to the pellets. For example, the pellets can have a higher water activity because, in some embodiments, they are cooked along with the substrate to provide a cooked pellet-coated food product. Furthermore, when the food product is cooked, the pellets expand and/or puff and become less dense, crunchy, crispy, or flaky as applicable, for example, so the pellets resemble the appearance, texture, and/or taste of a breading, cracker, chip-crumble, puffed-grain, Japanese crumble, or panko-crumble, as desired for a particular food product. In some embodiments, after air puffing, pellets have a moisture content of about 2-4 wt. %. As can be seen, by using pellets a given property of the pellets can be varied from processing to serving. Accordingly, the property can be configured, for example, to have one value that is desirable for processing while processing and a different value that is desirable for serving when serving.

As yet another advantage, in some embodiments a consumer can see the transformation in appearance of the pellets. For example, if a consumer cooks a frozen, pellet-coated food product (e.g., in an oven, toaster, fryer, microwave, etc., or any combination thereof), the consumer will see that the originally unexpanded, uncooked pellets on the outer surface of a substrate expand, and/or change color. Accordingly, in some embodiments, the pellets can provide a food product with a dramatic transformation in appearance. This in turn can provide, for example, a desirable culinary and/or dining experience for some consumers.

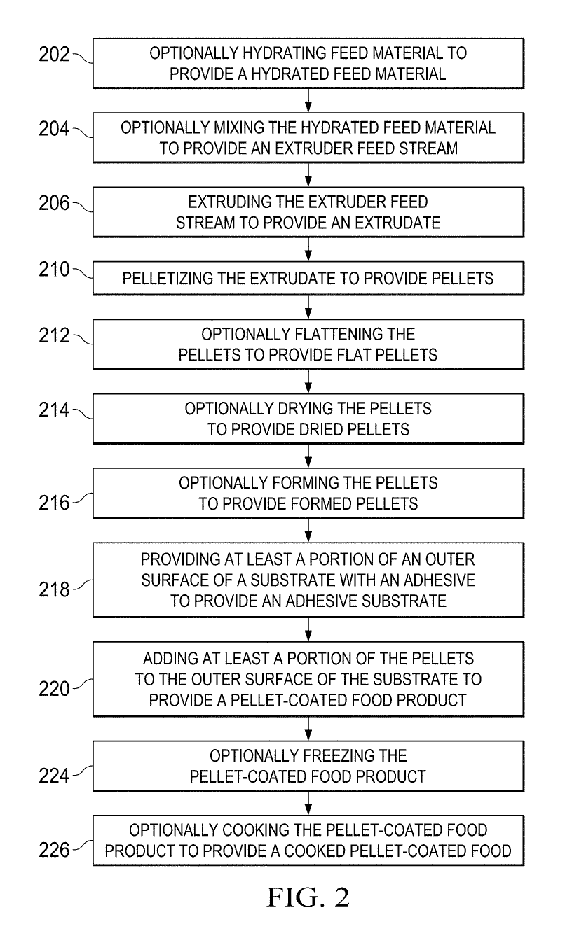

An embodiment of the invention will now be described with reference to FIG. 2, which depicts a schematic flow chart illustrating a method for producing a pellet-coated food product 124. First, an optional feed-material-hydrating step 202 comprises hydrating a feed material 102 to provide the extruder feed stream 110. In the feed material hydrating step, a liquid comprising, consisting of, or consisting essentially of water 104 is added to the feed-material 102. For example, the feed-material-hydrating step 202 can be useful if the feed material 102 is highly cooked and needs to be rehydrated. In some embodiments, the hydrating step comprises the feed material 102 absorbing the liquid, for example, so that the liquid is dispersed in the interstitial spaces of the feed material 102. Although the optional feed-material-hydrating step 202 is shown before extrusion, the feed-material-hydrating step can alternatively or additionally occur during extrusion in some embodiments.

Second, an optional feed-material-mixing step 204 comprises mixing a feed material 102 to provide the extruder feed stream 110. For example, the feed material 102 can be highly cooked, cooked, partially cooked, uncooked, dried, etc. Furthermore, some embodiments comprise a feed-material-mixing-and-hydrating step comprising hydrating and mixing a feed material 102 to provide the extruder feed stream 110. For example, the feed-material-mixing-and-hydrating step can comprise the feed-material-hydrating step 202 and the feed-material-mixing step 204, which can occur simultaneously. The steps can also occur sequentially or partially sequentially. For example, the feed-material-mixing step 204 can be begin, then the feed-material-hydrating step 202 can begin as water 104 is added, then the feed-material-mixing step 204 can continue simultaneously with the feed-material-hydrating step 202.

Third, an optional pellet-extruding step 206 comprises extruding the extruder feed stream 110 to provide an extrudate 112 (e.g., in the form of a sheet). Optionally, the extruding step comprises extrusion cooking the extruder feed stream 110 to provide the extrudate 112. As an example, the extrusion cooking can comprise partially cooking the extruder feed stream 110. Alternatively, in some embodiments, the extruding step does not comprise cooking or partially cooking the extruder feed stream 110. For example, given a feed material 102 that has been highly cooked, it can be undesirable to further cook the feed material in the extruding step. Additionally, in some embodiments, the extrusion step comprises a pellet-forming step 216. For example, an extruder die can be used to provide pellets 114 with a desired form (e.g., shape and/or size). Although, forming can alternatively or additionally be done in a later pellet-forming step 216. For example, the pellet-forming step 216 can comprise grinding the pellets 114 to provide the pellets with a desired form.

Fourth, an optional pelletizing step 210 comprises pelletizing (e.g., cutting) the extrudate 112 to provide extruded pellets 114. For example, the pelletizing step 210 can comprise providing the extruded pellets 114 with a desired shape and/or size. In some embodiments, the size of the pellets can affect the adherence of the pellets to a substrate. As an illustration, for a given smaller shape (e.g., sphere) with a smaller volume compared to a larger embodiment of the same shape (e.g., sphere), there is more surface area to volume (and weight) for the smaller shape than the larger shape. This can be advantageous because, for example, it can help the pellets remain adhered to a substrate when other variables (e.g., presence of, absence of, or type of batter and/or adhesive) remain constant. Additionally, in some embodiments, the pellets 114 can be shaped to be ruffled or waved, and upon expansion provide a ruffled or waved shape similar to RUFFLES® brand potato chips.

Fifth, an optional pellet-flattening step 212 comprises flattening the pellets 114 to provide flat pellets 116.

Sixth, an optional pellet-drying step 214 comprises drying the pellets 114 to provide dried pellets 118.

Seventh, an optional pellet-forming step 216 comprises forming the pellets 114 to provide formed pellets 120 (e.g., shaped and/or sized pellets 114). The pellet-forming step 216 can comprise reducing pellet sizes of the pellets 114 by abrading, grinding, milling, crushing, or cutting the pellets 114 to provide desired sizes, or to remove surface features such as projections. For example, in some embodiments forming (e.g., grinding) extruded pellets 114 can provide formed pellets 120 (e.g., ground pellets 114) that, after cooking, have a substantially different appearance, shape, size, and/or texture than the extruded, unformed pellets 120 (e.g., unground pellets 114). As other examples, in some embodiments, the pellets can be generally cylinder-shaped (e.g., hollow-cylinder-shaped) upon extrusion and optionally have the appearance of crumbled chips when ground. As another alternative, in some embodiments, the pellets can be generally corkscrew-shaped upon extrusion and optionally have the appearance of a crumbled chip when ground. As another alternative, pellets can be generally shaped like flat chips or ridged, flat chips, but upon cooking have the appearance of scoops (e.g., a portion of a spherical shape, e.g., hemisphere-like or bowl-like).

Eighth, an adhesive-providing step 218 comprises providing an adhesive to adhere the pellets 114 to the substrate 122. For example, in some embodiments, the adhesive providing step comprises providing at least a portion (e.g., at least about 5, 10, 20, 30, 40, 50, 60, 70, 80, 90, 95, or 100% of the surface area) of an outer surface of a substrate 122 with an adhesive to provide an adhesive substrate 123. In some embodiments, the adhesive-providing step 218 comprises coating the outer surface with an adhesive (e.g., batter, glaze, etc.) or a substance that causes the substrate 122 to become adhesive. Additionally, in some embodiments, the adhesive-providing step 218 comprises providing an adhesive substrate 123 (e.g., inherently adhesive substrate 123) comprising an adhesive outer surface. Moreover, in some embodiments, the adhesive providing step comprises providing pellets 114 with an adhesive to adhere the pellets 114 to the substrate 122.

Ninth, a pellet-applying step 220 comprises applying (e.g., adhering) at least a portion of the pellets 114 to the outer surface of the substrate 122 to provide a pellet-coated food product 124. For example, the pellet-coated food product 124 can comprise the substrate 122 and the pellets 114. Some embodiments optionally include a breading-application step, which can occur sequentially or simultaneously with the pellet-applying step 220 to provide a substrate 122 with a pelletized coating and a breading. For example, in some embodiments, the breading-application step is followed by the pellet-applying step 220 or vice-versa. As another example, in some embodiments the pellets 114 are inclusions in a breading and the pellet-applying step 220 and the breading-application step occur simultaneously. Furthermore, in some embodiments, the pellet-applying step 220 comprises applying dried pellets 118 to the substrate 122. Accordingly, a pellet-drying step 214 can occur before the pellet-applying step 220.

Tenth, an optional food-product-freezing step 224 comprises freezing the food product to provide a frozen food product 126. In some embodiments, the pellets 114 are unexpanded and/or uncooked when they are frozen. For example, in some embodiments, the extruded pellets 114 have not been finish-cooked (e.g., fried, baked, etc.) or partially cooked (e.g., par-fried). Accordingly, in some embodiments, when a consumer cooks the frozen food product 126 (e.g., at home) the pellets 114 will change in appearance, change in texture, puff and/or expand.

Eleventh, an optional food-product-cooking step 226 comprises cooking the food product to provide a cooked food product 128. The food-product-cooking step 226 can comprise, for example, baking, frying, and/or microwaving. In some embodiments, the food-product-cooking step 226 comprises expanding the pellets 114 on the food product to provide a cooked food product 128. In some embodiments, the cooked food product 128 comprises cooked, expanded pellets 129 and/or a cooked substrate 127. In some embodiments, the degree of expansion can depend on the pellet composition, including for example, water content. As an example, in some embodiments, pellets can expand to at least about 1.1, 1.2, 1.3, 1.4 1.5, 1.6, 1.7, 1.8, 1.9, 2, 3, 4, 5, 6, 7, 8, 9, or 10 times their pre-expanded volume. For example, in some embodiments, after expansion, the longest distance across a pellet is at least two times greater than the longest distance across the pellet before expansion.

As can be seen, in some embodiments, some of the steps illustrated in FIG. 2 are optional. Furthermore, in some embodiments, additional non-illustrated steps can also be included to provide pellet-coated-food product with desired characteristics. Moreover, in some embodiments, the orders of listed steps are modified (e.g., switched, re-ordered, performed simultaneously, performed sequentially, etc. as appropriate).

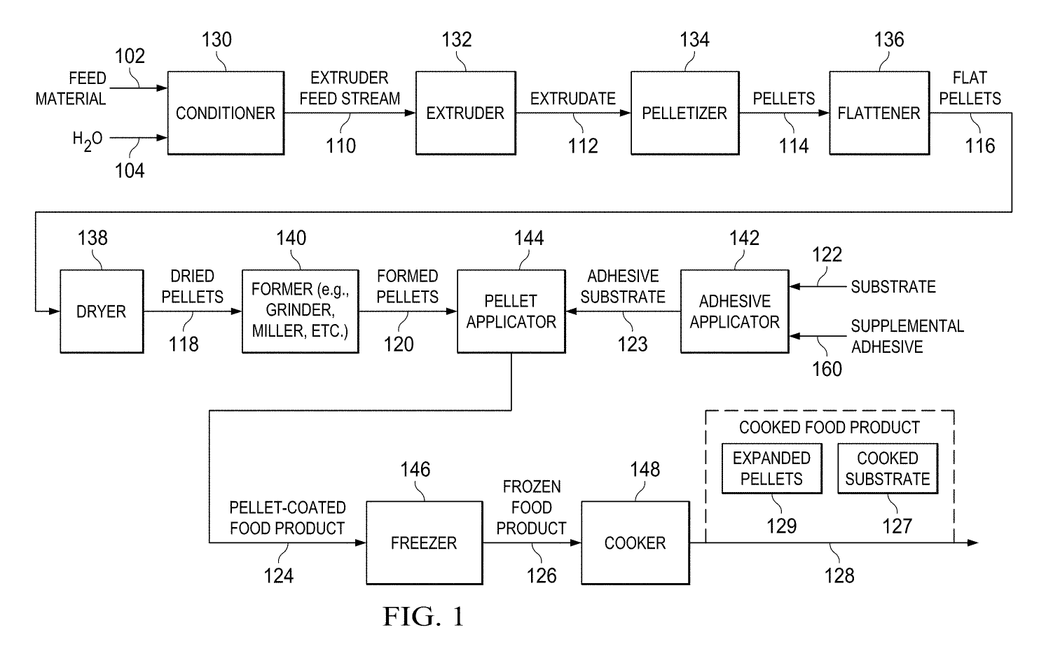

An embodiment of the invention will now be described with reference to FIG. 1, which depicts a block flow diagram illustrating a method for producing a pellet-coated food product 124.

First, an optional feed-material-conditioning step comprises feeding a feed material 102 to a conditioner 130 (e.g., hydrator, mixer, heater, cooler, steam injector, etc.) to provide an extruder feed stream 110. The conditioner 130 conditions the feed material 102 to provide an extruder feed stream 110 with desired characteristics (e.g., homogeneity, moisture, absorption, temperature, etc.). In some embodiments, the feed-material-conditioning step comprises a feed-material-hydrating step 202 and/or a feed-material-mixing step 204. In some embodiments, feed material 102 and water 104 are fed to the conditioner 130 to provide the extruder feed stream 110.

Second, an optional pellet-extruding step 206 comprises feeding the extruder feed stream 110 to an extruder 132 to provide an extrudate 112.

Third, an optional pelletizing step 210 comprises feeding the extrudate 112 to a pelletizer 134 (e.g., cutter, slicer, separator) to provide extruded pellets 114.

Fourth, an optional pellet-flattening step 212 comprises feeding the pellets 114 to a flattener 136 to provide flat pellets 116. In some embodiments, the pellet-flattening step 212 comprises contacting the pellets with a roller bar to flatten the pellets after the pellets are extruded. For example, the pellets can be conveyed under a roller bar (e.g., metal roller bar). In some embodiments the pellets (e.g., upon extrusion) have a moisture content (e.g., water content) of about 27-33, about 28-32, about 29-31, or about 30 wt. % water. Furthermore, in some embodiments, after flattening, the pellets comprise about 8.5-14.5, about 9-14, about 10-12, or about 10.5-11.5 wt. % water.

Fifth, an optional pellet-drying step 214 comprises feeding the pellets 114 to a dryer 138 to provide dried pellets 118.

Sixth, an optional pellet-forming step 216 comprises feeding the pellets 114 to a former 140 (e.g., abrader, grinder, miller, crusher, or cutter) to provide formed pellets 120.

Seventh, an adhesive-providing step 218 comprises feeding an adhesive to an adhesive applicator 142 to provide an adhesive substrate 123 or adhesive pellets 114. For example, the adhesive-providing step 218 can comprise feeding at least a portion of an outer surface of a substrate 122 and an adhesive (e.g., supplemental adhesive 160 or water 104 to activate the adhesiveness of an inherently adhesive outer surface) to an adhesive applicator 142 to provide an adhesive substrate 123. As another example, the adhesive-providing step 218 can comprise feeding at least a portion of the pellets 114 and an adhesive (e.g., supplemental adhesive 160 or water 104 to activate the adhesiveness of an inherently adhesive outer surface of the pellets 114) to an adhesive applicator 142 to provide an adhesive pellet.

Ninth, a pellet-applying step 220 comprises feeding at least a portion of the pellets 114 and a substrate 122 to a pellet applicator 144 (e.g., a breading machine, which can include breading machines made by JBT Food Tech of Alpharetta, Ga., US) to provide a pellet-coated food product 124. For example, adhesive pellets 114 can be applied to a substrate 122 (e.g., adhesive or non-adhesive substrate 123) to provide the pellet-coated food product 124. Similarly, pellets 114 (e.g., adhesive or non-adhesive pellets 114) can be applied to an adhesive substrate 123 to provide the pellet-coated food product 124.

Tenth, an optional food-product-freezing step 224 comprises feeding the food product (e.g., pellet-coated food product 124) to a freezer 146 to provide a frozen food product 126 (e.g., frozen pellet-coated food product 124).

Eleventh, an optional food-product-cooking step 226 comprises cooking the food product (e.g., frozen, thawed, or unfrozen pellet-coated food product 124) in a cooker 148 to provide a cooked food product 128 (e.g., cooked pellet-coated food product 124). For example, the cooked food product 128 can comprise cooked pellets 114 and/or a cooked substrate 127. The cooked food product 128 can also comprise expanded pellets 129. For example, the cooking process can cause the pellets 114 to expand.

As a skilled person would recognize, several steps are optional.

In some embodiments, a pellet is an unexpanded product, for example, a half product. A product is a half product when it needs another step to provide a finished product (e.g., to expand and/or make the product consumable). For example, regular breading and puffed rice are not considered a half product. They are considered a finished product, can be eaten as they are, and are typically eaten as they are. In contrast, some pellets, apart from not being a finished product, are so hard they could not be chewed (easily or at all) before being expanded.

In some embodiments, an unexpanded and/or uncooked pellet (or each of a plurality of pellets) has a density of about 100-900, 100-150, 150-220, 200-900, 220-250, 250-500, 500-900, 600-900, 650-850, 700-800, 725-775, 750, 600-700, 700-800, or 800-900 grams per liter (“g/L”) at 25° C. In some embodiments, an unexpanded and/or uncooked pellet (or each of a plurality of pellets) has a density that is some combination of the previously described ranges or points, or a range formed by endpoints selected from values contained in the previously described ranges or points. In some embodiments, an expanded and/or cooked pellet (or each of a plurality of pellets) has a density of about 25-200, 30-42, 50-175, 50-60, 60-100, 75-150, 100-125, 100-150, 25-75, 75-125, 125-175, 175-200, or 150-200 g/L at 25° C. In some embodiments, an expanded and/or cooked pellet (or each of a plurality of pellets) has a density that is some combination of the previously described ranges or points, or a range formed by endpoints selected from values contained in the previously described ranges or points.

As an example, in some embodiments, an unexpanded and/or uncooked pellet (or each of a plurality of pellets) has a density of about 220-250 g/L at 25° C. (e.g., 235 g/L at 25° C.), and, when expanded and/or cooked, the pellet (or each of a plurality of pellets) has a density of about 50-60 g/L at 25° C. As another example, in some embodiments, an unexpanded and/or uncooked pellet (or each of a plurality of pellets) has a density of about 100-150 g/L at 25° C. (e.g., 133 g/L at 25° C.), and, when expanded and/or cooked, the pellet (or each of a plurality of pellets) has a density of about 30-42 g/L at 25° C. In some embodiments, the pellet or pellets can be in the shape of a ring. In some embodiments, the pellet or pellets made from extruded potato chips.

In some embodiments, the density of the expanded pellets at 25° C. is about 1/36 to ½, 1/30 to ½, 1/24 to ½, or 1/12 to ½, or 1/10 to ½, or ⅕ to ½, or 1/7 to ⅓, or ⅙ to ¼ of the density of the unexpanded pellets. In some embodiments, an expanded pellet (or each of a plurality of pellets) has a density that is some combination of the previously described ranges, or a range formed by endpoints selected from values contained in the previously described ranges.

In some embodiments a pellet is mildly cooked and formed to provide a half product. The cooking of the material prior to forming the pellet does not depolymerize all the starch. For example, in some embodiments, about 10-45, 20-35, or 25-30 wt. % of the starch is depolymerized. Moreover, in some embodiments, the remaining starch (e.g., the starch that is not depolymerized) is unchanged, polymerized, and/or remains crystalized.

In some embodiments, the pellet comprises a moisture content (e.g., water content) of about 8.5-14.5, about 10-12, or about 10.5-11.5 wt. %.

In some embodiments, a pellet comprises a primary component. In some embodiments, a pellet is primary-component-based (e.g., comprising at least about 60, 70, 80, 90, 95, or 100 wt. % of the primary component). In some embodiments, the remainder (e.g., non-primary-component portion) of a pellet comprises, consists, or consists essentially of a cereal, a flour, a salt, an emulsifier, or a gelatinized starch. For example, in some embodiments, the primary component is at least a portion of a material selected from the group consisting of potato (e.g., potato flakes, potato granules, gelatinized potato, etc.) corn, rice tapioca, beans, wheat etc. and any combination thereof. Accordingly, in some embodiments, the feed material 102 for a pellet 114 is primary-component-based (e.g., comprising at least about 60, 70, 80, 90, 95, or 100 wt. % of the primary component).

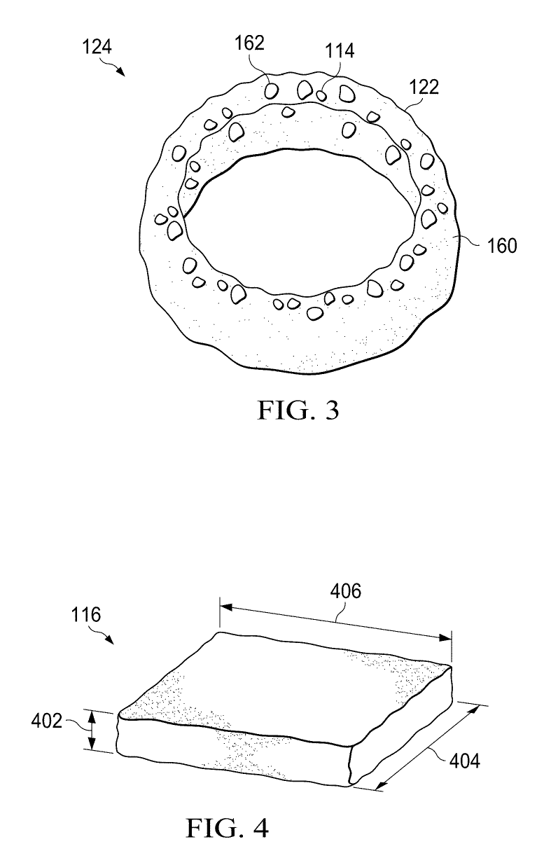

One embodiment of the invention will now be discussed with reference to FIG. 3, which illustrates a frozen, pellet-coated food product 124. For example, in some embodiments, a frozen, pellet-coated food product 124 comprises a substrate 122 comprising an outer surface and a substrate coating adhered to the outer surface of the substrate 122. As illustrated, the substrate coating comprises pellets 114. The illustrated substrate coating also comprises breading 162. In some embodiments, the pellets 114 are unexpanded. For example, in some embodiments, the pellets 114 are half-products, the pellets 114 have not been expanded before freezing, or the food product comprising the pellets 114 has not been finish-cooked before freezing. Accordingly, although the substrate 122 may have already been cooked or even finish-cooked, in some embodiments, the pellets 114 are uncooked or only partially cooked, but not finish cooked. For example, in some embodiments, pellets 114 are cooked (e.g., finish-cooked) to expand the pellets 114.

In some embodiments, the substrate coating is adhered to the outer surface of the substrate 122 with an adhesive (e.g., supplemental adhesive 160).

In some embodiments, the pellets 114 comprise about 10-45 wt. % depolymerized starch. Furthermore, in some embodiments, the pellets 114 comprises about 8.5-14.5 wt. % non-covalently bound water 104. Additionally, in some embodiments, the pellets 114 comprise at least about 50, 60, 70, 80, 90, 95, 99, or 100 wt. % of a primary component (e.g., potato, corn, rice tapioca, beans, wheat, etc. and any combination thereof).

In some embodiments, the pellets 114 comprise seasoning in addition to a primary component. Additionally, in some embodiments, seasoning adheres to the surface of the pellets 114. Moreover, in some embodiments, seasoning is added to a food product (e.g., the substrate 122 and/or the pellets 114) before the food product is frozen.

In some embodiments, the food product comprising the substrate 122 and the coating (e.g., pellets 114 and/or breading 162) is uncooked. For example, the coating and substrate 122 can be cooked or uncooked; however, the food product as a whole has not yet been cooked and the pellets 114 have not been more than partially cooked after being formed. Furthermore, in some embodiments, the pellets 114 are unexpanded.

In some embodiments, the food product is partially cooked (e.g., par-fried or partially baked).

In some embodiments, the food product comprises breading 162, for example, the substrate coating comprises pellets 114 and breading 162. In some embodiments, the breading 162 and pellets 114 are adhered to the outer surface of the food product. In some embodiments, the breading 162 and pellets 114 are mixed to provide a substrate coating. Furthermore, in some embodiments, the pellets 114 are inclusions in the breading 162. This can give visual impact and differentiated texture to the breading 162. For example, a pork pellet can be mixed into a Japanese bread crumb to give the appearance of a bacon bit inclusion, even if the pellet is not physically imbedded in bread crumbs. As another illustration, a pellet inclusion in a breading can be provided, for example, by mixing 40 wt. % pellets with 60 wt. % bread crumbs.

In some embodiments, the substrate coating comprises, consists essentially of or consists of pellets 114. For example, in some embodiments, the pellets 114 provide at least about 5, 10, 20, 30, 40, 50, 60, 70, 80, 90, 95 or wt. % of a total mass of the substrate coating.

In some embodiments, the food product comprises a supplemental adhesive 160. For example, the supplemental adhesive 160 can be selected from a batter (e.g., comprising flour and/or egg), and a glaze (e.g., comprising sugar, or a sugar solution). An example of a glaze is an aqueous 20 wt. % corn syrup solution.

In some embodiments, the pellets 114 are made by extruding, sheeting (e.g., flattening into a sheet, for example, to enable shaped cutting of pellets from the sheet), pelletizing and forming a feed material 102 selected from the group consisting of animal matter, plant matter, and dairy matter. Additionally, in some embodiments, the feed material 102 is selected from the group consisting of dried or cooked matter. Examples of cooked matter include baked matter, fried matter, etc. and combinations thereof.

In some embodiments, the feed material 102 is selected from animal matter (e.g., beef jerky, pork rinds, bacon pieces), plant matter (e.g., raisins, dehydrated potatoes, potato flakes, potato granules, potato cubes, grains, bread, chips), dairy products (e.g., cheese powder, cheese crisps), and combinations thereof, any of which can be raw, pasteurized, dried, and/or cooked as appropriate.

In some embodiments, the pellets 114 are made from animal matter, and the animal matter is selected from the group consisting of meat (e.g., chicken, beef, pork, etc.), other animal products (e.g., pork rinds), and combinations thereof.

In some embodiments, the pellets 114 are made from plant matter, and the plant matter is selected from the group consisting of vegetables (e.g., potatoes, tubers, seaweed), cereal grains (e.g., oat, barley, wheat, sorghum, corn, rice, etc.), pulses (e.g., chickpeas, beans, etc.), fruits (e.g., grapes, cranberries, apples, oranges, peppers), portions of plants (e.g., starch, potato starch, corn starch), and combinations thereof. In some embodiments, peppers include jalapeno, chili, bell, and combinations thereof.

In some embodiments, a coating comprises pellets 114 made from different material. For example, the pellets 114 can comprise a pellet mix of about 60-80, 65-75, or 70 wt. % potato and about 40-20, 35-25, or 30 wt. % pork pellet. Upon coating a substrate 122 with the pellet mix to provide a food product, and cooking the food product, the food product could provide a coating that is crispy like cooked potatoes while including a taste similar to that provided by bacon pieces.

One embodiment of the invention will now be illustrated with reference to FIG. 4, which depicts a pellet that has been flattened to approximate a planar shape (e.g., a piece of a chip crumble). As illustrated, the flat pellets 116 can be thin in a first dimension 402 (e.g., no more than about 2, 3, 4, 5 mm) and elongated in at least one other dimension (e.g., more than about 2, 5, 10, 15, 20, or 25 mm; no more than about 5, 10, 15, 20, 25, or 25.4 mm; and/or some combination thereof) to provide a pellet-coated food product 124 with a texture similar to a chip crumble after the food product is finish cooked. For example, in one embodiment, the at least one other dimension is a second dimension 404 (e.g., ribbon-like) or a second dimension 404 and a third dimension 406 (e.g., somewhat planar). As illustrated in FIG. 4, the dimensions are measured along three mutually orthogonal axes, for example, X-, Y-, and Z-axes in a Cartesian coordinate system.

In some embodiments, the pellets 114 are shaped, are sized, and/or have a composition so that, after cooking, the pellets 114 approximate a chip crumble in at least one characteristic selected from the group consisting of appearance, texture, taste and any combination thereof. Furthermore, in some embodiments, the pellets on a pellet-coated food product, after finish cooking, comprise a moisture content of 2-4 wt. % and/or a water activity of less than about 2.5, 3.0, or 3.5.

In some embodiments, a pellet is extruded, and then flattened prior to drying to provide a flat pellet that is a chip-like-pellet. In some embodiments, a pellet is ground to provide at least one flat pellet that is a chip-like pellet. In some embodiments, a substrate 122 can be coated with a plurality of flat and/or flattened pellets 114 to provide a chip-crumble-like substrate coating.

In some embodiments, the pellets 114 are shaped, are sized, and/or have a composition to provide an appearance, texture, taste, or some combination thereof to approximate pieces of an onion-flavored, extruded, corn-based product (e.g., FUNYUNS® brand products). In some embodiments, the pellets 114 are made from a feed material that comprises a wheat base mixed with onions and/or onion powder.

Similarly, in some embodiments, the substrate 122 is shaped, is sized, and/or has a composition to provide an appearance, texture, taste, or some combination thereof to approximate pieces of an onion-flavored, extruded, expanded, corn-based product (e.g., FUNYUNS® brand products). For example, in some embodiments, the substrate 122 is an extruded product (e.g., extruded, expanded corn-based product).

As another example, in some embodiments, the food product is a pellet-coated onion ring. For example, the substrate 122 can be an onion. Additionally, the pellets 114 can be made from at least a portion of an onion. Furthermore, in some embodiments, the food product is frozen and not more than partially cooked.

As another example, in some embodiments, the substrate is a chip (e.g., snack chip, for example, Doritos® brand chips) and the food product is a pellet-coated chip.

### Comparative Examples

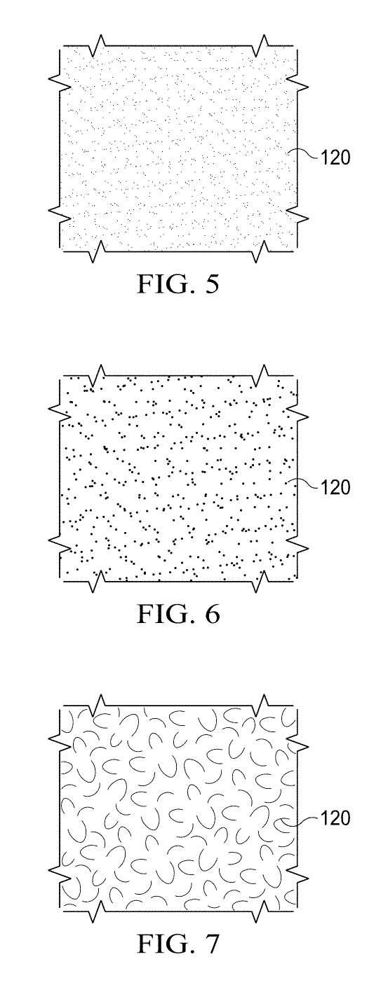

Illustrative embodiments of the invention will now be described with reference to FIG. 5, FIG. 6, and FIG. 7, which illustrate ground pellets made from a feed material comprising wheat and onion powder. For example, FIG. 5 depicts pellets 114 that have been ground to a relatively small size. The resulting formed pellets 120 are fine. For example, pellets can be sized large enough that about 70 wt. % are retained by a US No. 45/0.355 mm sized screen and/or the pellets can be sized small enough that about 80 wt. % pass through a US No. 30/0.60 mm sized screen.

FIG. 6 depicts pellets 114 that have been ground to a relatively moderate size. The resulting formed pellets 120 are moderately fine/coarse. For example, pellets can be sized large enough that about 99 wt. % do not pass through a US Mesh No. 14/1.40 mm screen, about 98 wt. % do not pass through a US Mesh No. 12/1.70 mm screen, about 96 wt. % do not pass through a US Mesh No. 10/2.00 mm screen, and/or about 69 wt. % do not pass through a US Mesh No. 6/3.35 mm screen. Additionally, pellets can be sized small enough that about 100 wt. % pass through a US Mesh No. 4/4.75 mm screen, about 31 wt. % pass through a US Mesh No. 6/3.35 mm screen, about 4 wt. % pass through a US Mesh No. 8/2.36 mm screen, about 2 wt. % pass through a US Mesh No. 10/2.00 mm screen, about 1 wt. % pass through a US Mesh No. 12/1.70 mm screen, and/or about 1 wt. % pass through a US Mesh No. 14/1.40 mm screen.

FIG. 7 depicts pellets 114 that have been ground to a relatively large size. The resulting formed pellets 120 are coarse. For example, pellets can be sized large enough that about 73 wt. % do not pass through a US Mesh No. 25/0.71 mm screen, about 63 wt. % do not pass through a US Mesh No. 20/0.85 mm screen, about 53 wt. % do not pass through a US Mesh No. 18/1.00 mm screen, about 42 wt. % do not pass through a US Mesh No. 16/1.18 mm screen, about 29 wt. % do not pass through a US Mesh No. 14/1.40 mm screen, and/or about 14 wt. % do not pass through a US Mesh No. 12/1.70 mm screen. Additionally, pellets can be sized small enough that about 86 wt. % pass through a US Mesh No. 12/1.70 mm screen, about 71 wt. % pass through a US Mesh No. 14/1.40 mm screen, about 59 wt. % pass through a US Mesh No. 16/1.18 mm screen, about 47 wt. % pass through a US Mesh No. 18/1.00 mm screen, about 37 wt. % pass through a US Mesh No. 20/0.85 mm screen, and/or about 27 wt. % pass through a US Mesh No. 25/0.71 mm screen.

In some embodiments, pellets can have or can be ground to a particle size so that at least 99 wt. % of particles pass through a US Mesh No. 4/4.75 mm screen and/or at least 99 wt. % of pellets are retained by a US No. 74/0.074 mm screen.

Examples of size distributions for pellets are illustrated in Table 1 below, which shows the size distribution for onion pellets ground using a medium and large grind.

TABLE 1
Particle Size Distribution of Pellets
Large Grind

| | | | | | | | | |
|---|---|---|---|---|---|---|---|---|
| Screen Size | 4/4.75 | 6/3.35 | 8/2.36 | 10/2.00 | 12/1.70 | 14/1.40 | pan | Total |
| (US Mesh No./mm) | | | | | | | | |
| particles retained by | 0 | 68.66 | 27.18 | 2.02 | 0.86 | 0.63 | 0.65 | 100 |
| screen/pan (wt. %) | | | | | | | | |

Medium Grind

| | | | | | | | | |
|---|---|---|---|---|---|---|---|---|
| Screen Size | 12/1.70 | 14/1.40 | 16/1.18 | 18/1.00 | 20/0.85 | 25/0.71 | pan | Total |
| (US Mesh No./mm) | | | | | | | | |
| particles retained by | 14.44 | 14.48 | 12.54 | 11.56 | 9.69 | 10.36 | 26.94 | 100.01 |
| screen/pan (wt. %) | | | | | | | | |

Table 1 shows the results of passing pellets through successively smaller screens (e.g., while shaking or vibrating the screens and/or allowing the pellets to fall through the screens under the force of gravity) and catching the pellets that pass through all the screens in a pan. The Table shows the approximate weight percentage of pellets that were retained by (e.g., did not pass through) a particular screen size. For example, for the large grind pellets, no pellets were retained by a US mesh No. 4/4.75 micron sized screen, or, in other words, 100 wt. % of the pellets passed through a US mesh No. 4/4.75 micron sized screen. As other examples, 68.66 wt. % of the pellets were retained by a US mesh No. 6/3.35 micron sized screen and 0.65 wt. % of the pellets passed through a US mesh No. 14/1.40 micron sized screen. Furthermore, as a skilled person would understand upon reading the present disclosure (including the claims), although listed ranges and values are provided herein for several parameters, any ranges or values contained within the listed ranges and any ranges (or values within the ranges) formed using multiple listed values as endpoints provide alternative embodiments.

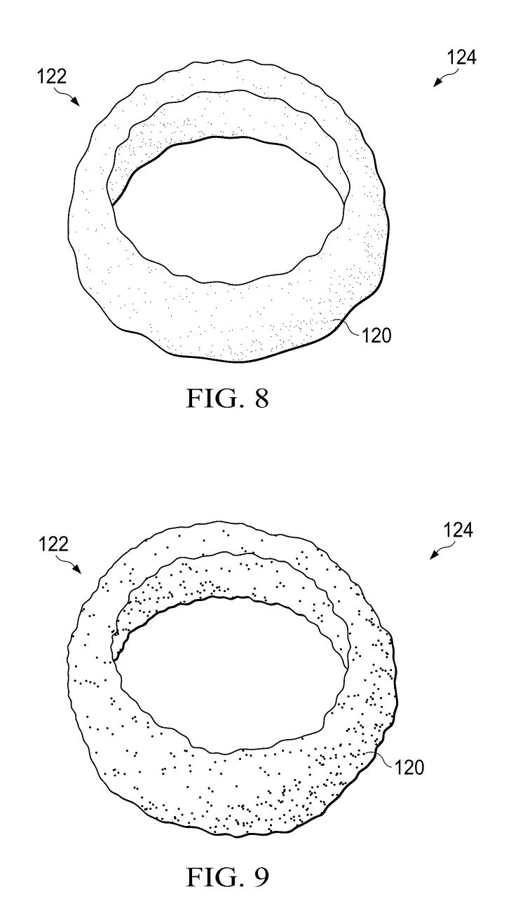

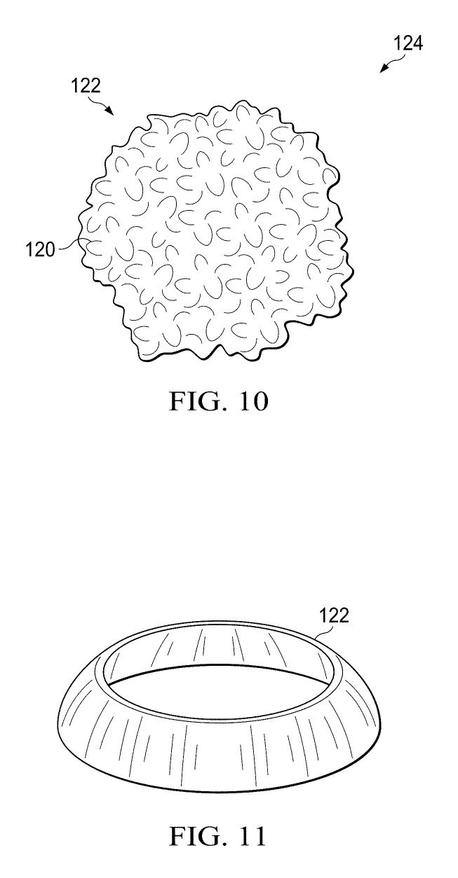

Embodiments of the invention will now be described with reference to FIG. 8, FIG. 9, FIG. 10, and FIG. 11. FIG. 8 illustrates a raw onion ring (e.g., portion of an onion) that has been coated with the fine pellets 114 (e.g., fine formed pellets 120) of FIG. 5. FIG. 9 illustrates a raw onion ring that has been coated with the moderately sized pellets 114 (e.g., moderately fine/coarse formed pellets 120) of FIG. 6. FIG. 10 illustrates a potato that has been coated with the coarse pellets 114 (e.g., coarse formed pellets 120) of FIG. 7. In some embodiments, the pellets (for example, bacon pellets) can expand up to 2, 3, 4, 5, 6, 7, 8, 9, or 10 times their original volume. FIG. 11 illustrates a raw uncoated (e.g., non-pellet-coated) onion ring, which can be a substrate 122.

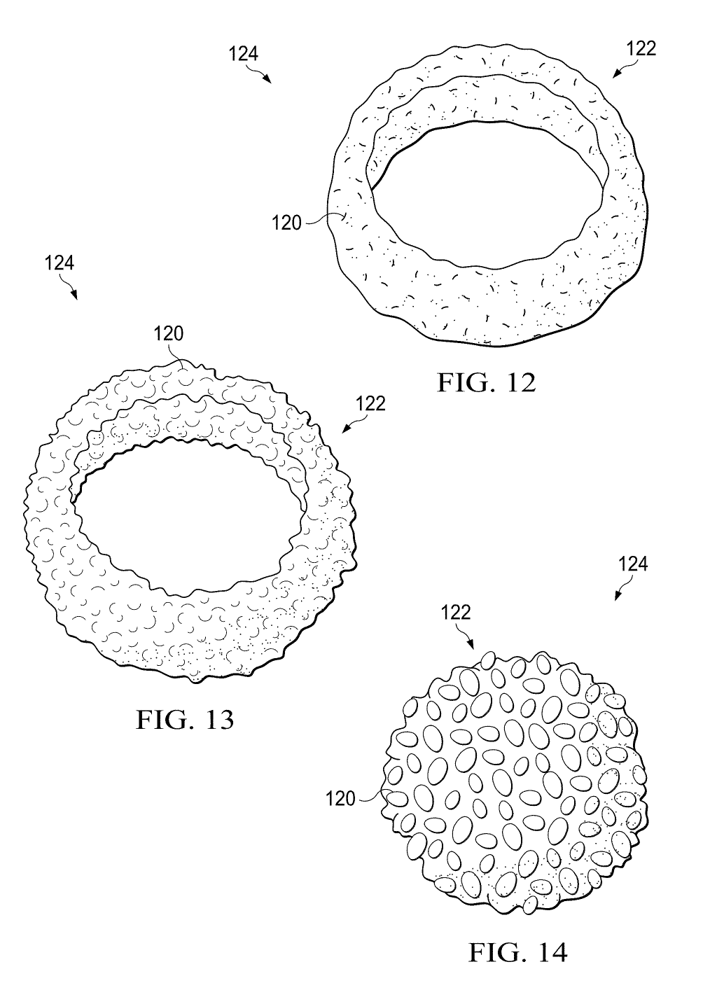

FIG. 12, FIG. 13 and FIG. 14 illustrate the food products (e.g., pellet-coated substrates 122) of FIG. 8, FIG. 9 and FIG. 10, respectively, after cooking (e.g., frying). For example, FIG. 12 illustrates a cooked, pellet-coated food product 124 comprising an onion substrate 122 that has been coated with the fine pellets 114 of FIG. 5. FIG. 13 illustrates a cooked, pellet-coated food product 124 comprising an onion substrate 122 that has been coated with the moderately sized pellets 114 (e.g., fine formed pellets 120) of FIG. 6. FIG. 14 illustrates a cooked, pellet-coated food product 124 comprising a potato substrate 122 that has been coated with the coarse pellets 114 (e.g., coarse formed pellets 120) of FIG. 7. The pellets can expand in varying amounts upon cooking, depending on the composition of the pellets and the cooking conditions.

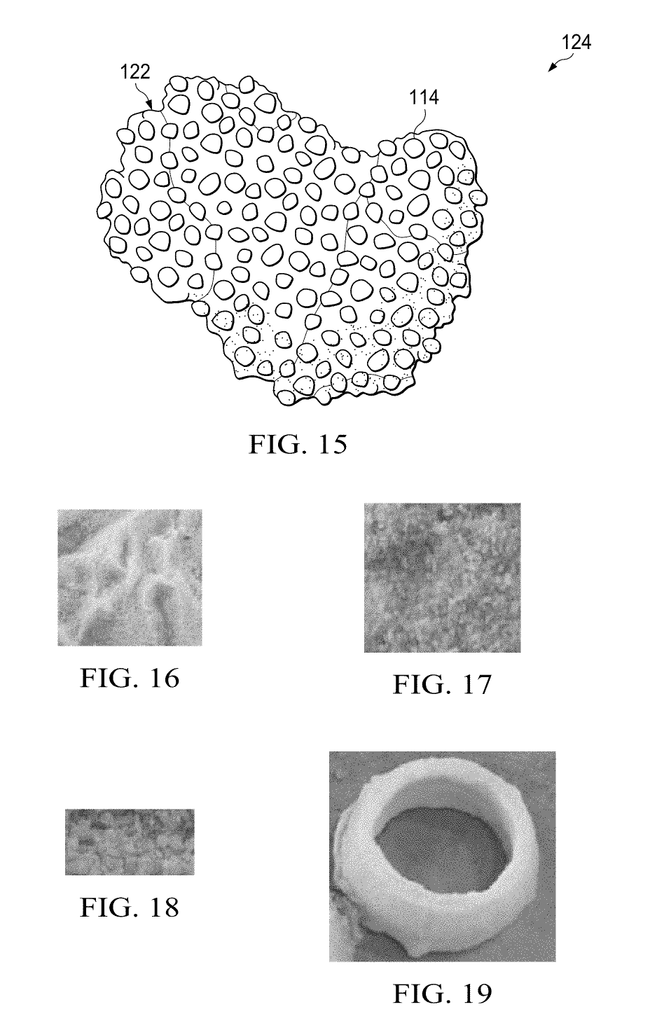

FIG. 15 illustrates a cooked, pellet-coated food product 124 comprising a substrate 122 and a coating. The substrate 122 is a portion of a peeled potato. The coating consists of pellets 114 made from pork rinds. The substrate 122 was coated with the pellets 114 and fried to provide the food product of FIG. 15. The pellets were adhered to the substrate using a batter.

In some embodiments, as the pellets 114 expand the differences in size become more pronounced, as illustrated. Additionally, in some embodiments, the shape of the food product formed using larger pellets 114 (e.g., the embodiment of FIG. 15) is noticeably more irregular than the shape of a food product formed by smaller pellets 114 (e.g., the embodiment of FIG. 12). Accordingly, relatively smaller changes in the size or shape of the pellets 114 can have magnified impacts on the shape of the pellet-coated food product 124 after the pellets 114 are expanded.

FIG. 16 is a gray-scale photograph of pellets corresponding to the pellets of FIG. 5 that have been ground to a relatively smaller size.

FIG. 17 is a gray-scale photograph of pellets corresponding to the pellets of FIG. 6 that have been ground to a relatively moderate size.

FIG. 18 is a gray-scale photograph of pellets corresponding to the pellets of FIG. 7 that have been ground to a relatively larger size.

FIG. 19 is a gray-scale photograph of an uncooked food product comprising a substrate that has been coated with the relatively smaller-sized pellets of FIG. 16.

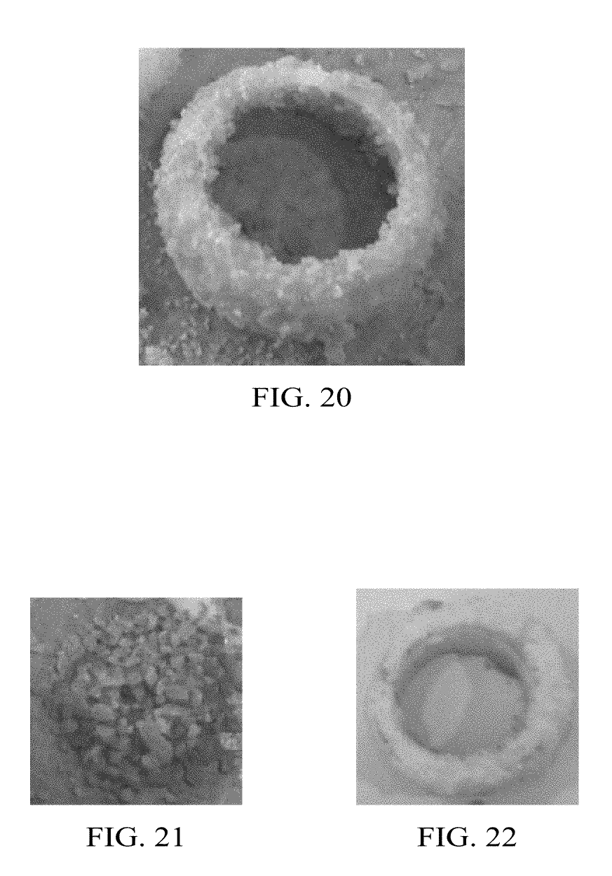

FIG. 20 is a gray-scale photograph of an uncooked food product comprising a substrate that has been coated with the relatively moderate-sized pellets of FIG. 17.

FIG. 21 is a gray-scale photograph of an uncooked food product substrate that has been coated with the relatively larger-sized pellets of FIG. 18.

FIG. 22 is a gray-scale photograph of a cooked food product formed by cooking the food product of FIG. 19.

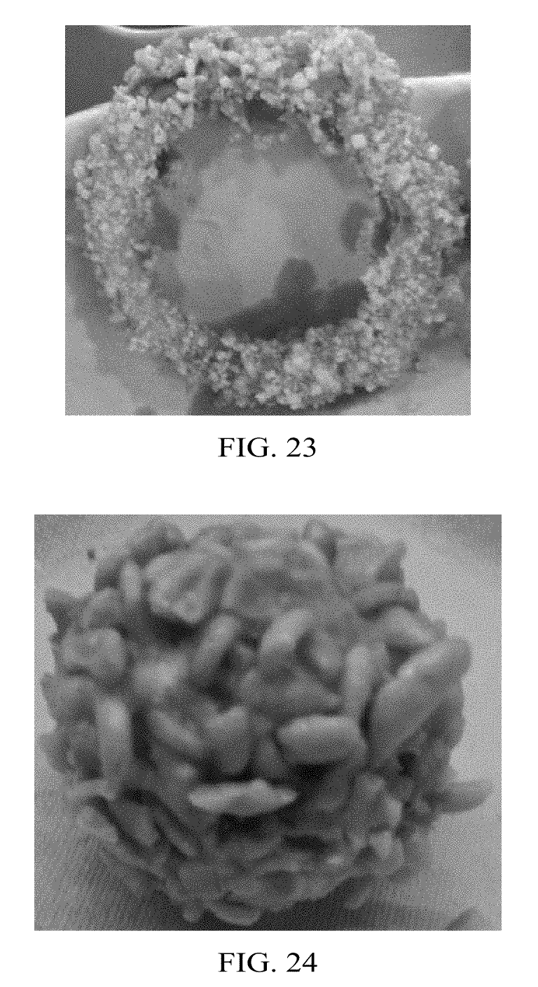

FIG. 23 is a gray-scale photograph of a cooked food product formed by cooking the food product of FIG. 20.

FIG. 24 is a gray-scale photograph of a cooked food product formed by cooking a food product comprising a potato ball substrate coated with bacon pellets. The pellets were ground to ¼ to ⅙ (e.g., ⅕) their original size before the substrate was coated with the pellets.

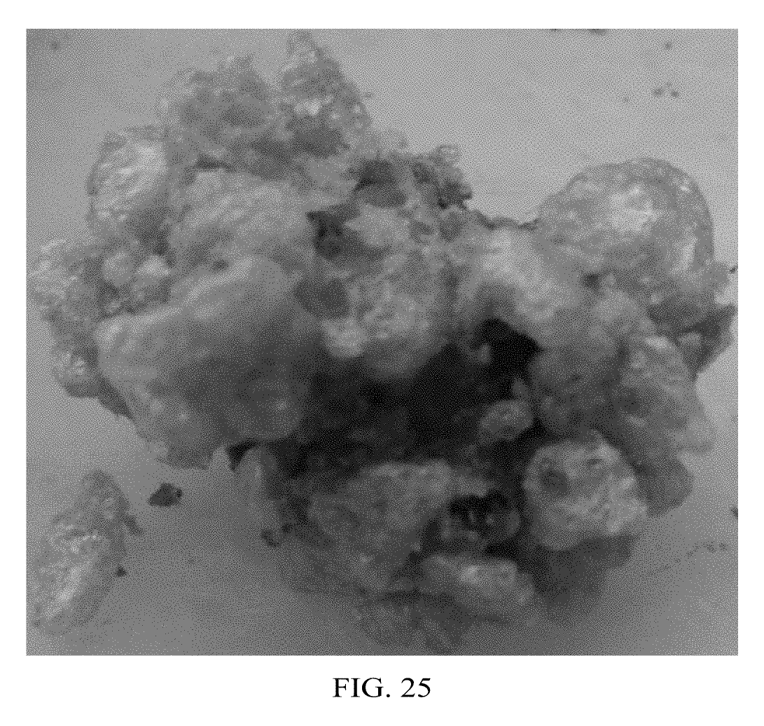

FIG. 25 is a gray-scale photograph of a cooked food product formed by cooking a food product comprising a potato ball substrate coated with unground bacon pellets. The food product of FIG. 25 is essentially the same as the food product of FIG. 24 except the pellets were not ground before being used to coat the substrate like the pellets in FIG. 24.

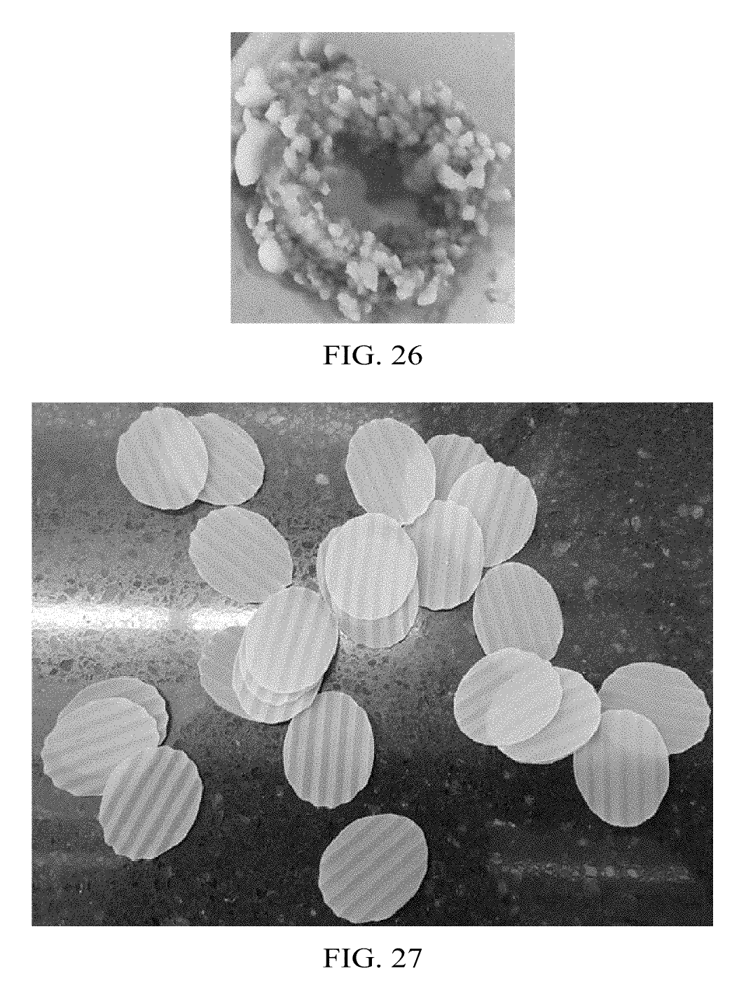

FIG. 26 is a gray-scale photograph of a cooked food product formed by cooking a food product coated with pellets that have been ground to a relatively larger size, for example, as illustrated in FIG. 18 and FIG. 21.

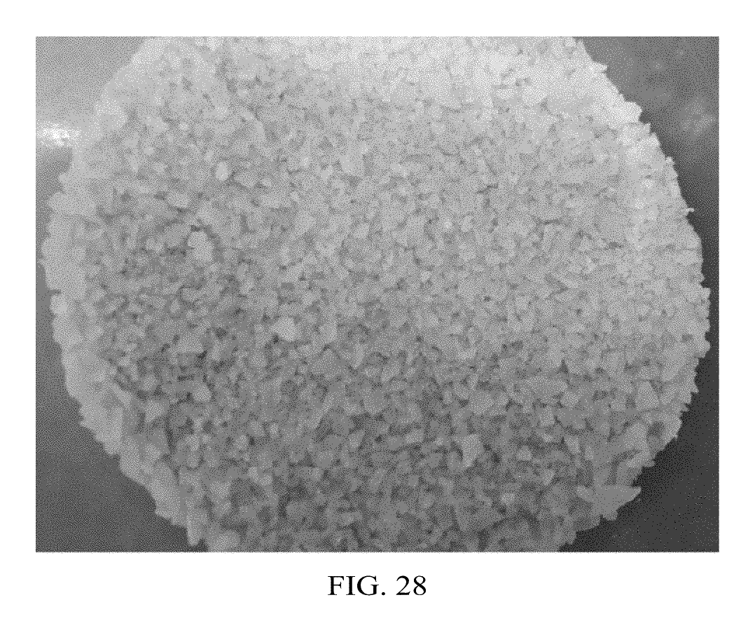

FIG. 27 is a gray-scale photograph of extruded, wavy, unground, uncooked chips.

FIG. 28 is a gray-scale photograph of pellets formed from extruded, wavy, ground, uncooked chips.

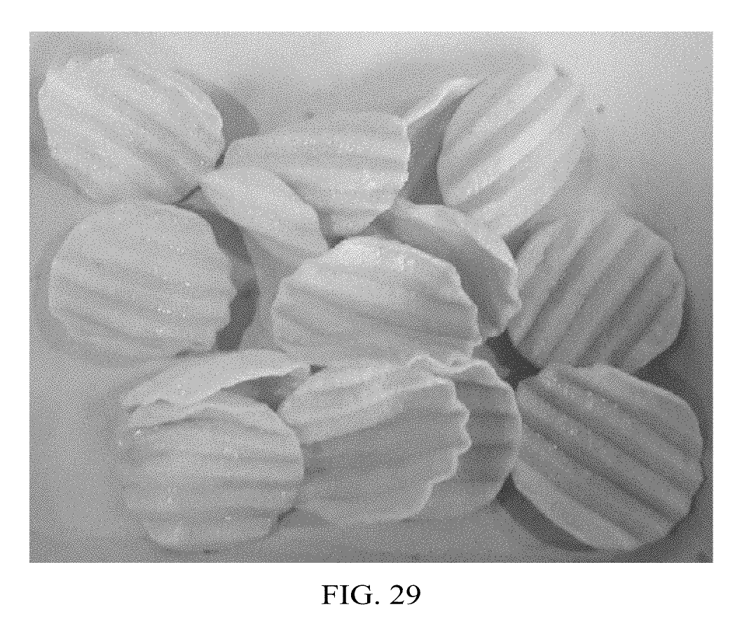

FIG. 29 is a gray-scale photograph of extruded, wavy, unground, cooked chips that have expanded so that some of the chips have a generally curved shape and look somewhat like scoops, for example, for dip. The chips were cooked by frying.

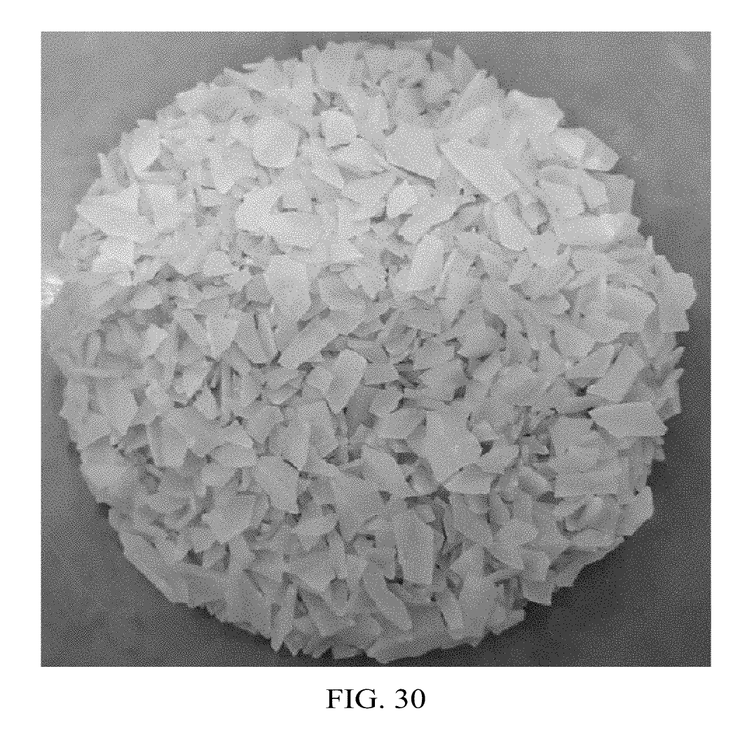

FIG. 30 is a gray-scale photograph of larger-sized pellets formed from extruded, uncooked chips (e.g., as illustrated in FIG. 27) that have been ground.

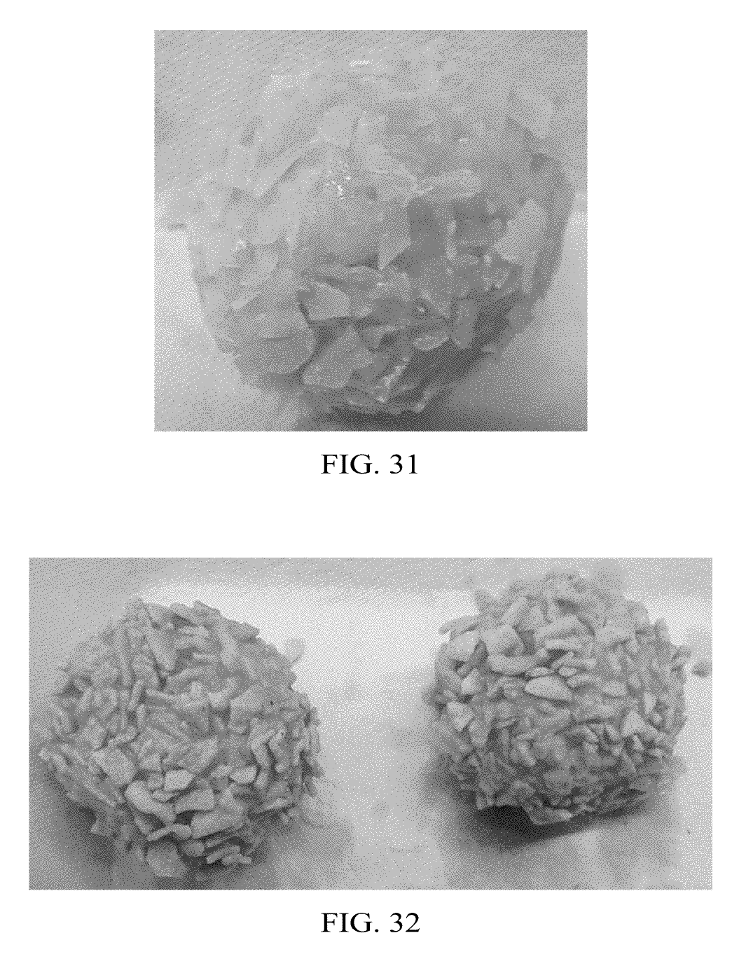

FIG. 31 is a gray-scale photograph of a food product comprising a mashed potato ball substrate coated with some of the pellets illustrated in FIG. 30 and then coated with an egg wash comprising egg whites.

FIG. 32 is a gray-scale photograph of food products comprising a mashed potato ball substrate that was coated with some of the pellets of FIG. 30, coated with an egg wash, for example, as illustrated in FIG. 31, and then cooked (e.g., fried).

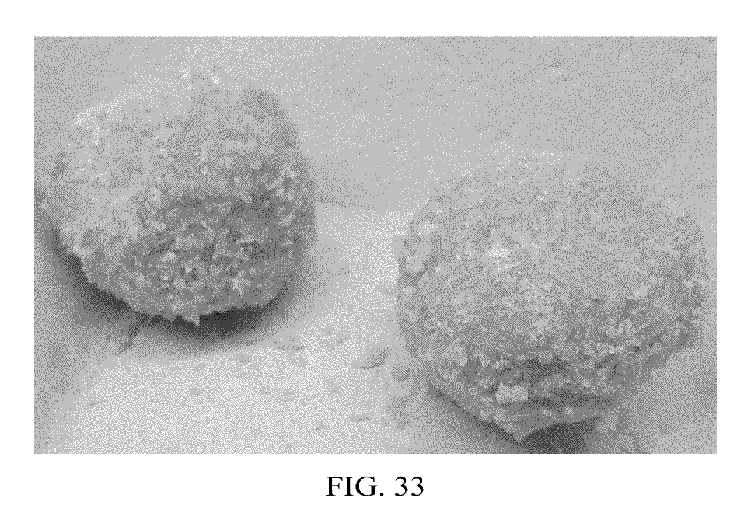

FIG. 33 is a gray-scale photograph of a food product comprising a pellet-coated substrate that has been fried. The substrate comprises a mashed potato ball. The pellets comprise pellets (e.g., formed from extruded, uncooked chips as illustrated in FIG. 27) that have been ground smaller than those shown in FIG. 30.

As can be seen, for example, in FIGS. 28 and 30, 31, extruded pellets that have been ground can provide appearances similar to that of a chip crumble. However, the pellets are more durable and can have a longer shelf-life than actual crumbled chips. Additionally, as illustrated, for example, in FIG. 32, after the pellets are cooked, they can expand to provide a texture that is similar to that a chip crumble. Furthermore, as illustrated herein, for example, the pellets can actually be formed by processes such as extrusion or grinding that provide coatings with unusual textures and appearances.

### Additional Embodiments

The following clauses are offered as further description of the disclosed invention:

1. A method comprising the steps:
extruding an extruder feed stream to provide an extrudate;
pelletizing the extrudate to provide extruded pellets;
drying the pellets to provide dried pellets;
providing at least a portion of an outer surface of a substrate with an adhesive to provide an adhesive substrate;
applying at least a portion of the pellets to the outer surface of the substrate to provide a pellet-coated food product comprising the substrate and the pellets; and
freezing the food product.
   2. The method of any of clauses 1-11, excluding the present clause, further comprising:
hydrating a feed material to provide the extruder feed stream.
   3. The method of any of clauses 1-11, excluding the present clause, further comprising:
mixing a feed material to provide the extruder feed stream.
   4. The method of any of clauses 1 and 5-11, further comprising:
hydrating and mixing a feed material to provide the extruder feed stream.
   5. The method of any of clauses 1-11, excluding the present clause, further comprising:
flattening the pellets to provide flat pellets.
   6. The method of any of clauses 1-11, excluding the present clause, further comprising:
forming the pellets to provide formed pellets with desired sizes.
   7. The method of any of clauses 1-11, excluding the present clause, further comprising:
cooking the food product to provide a cooked food product, optionally thereby expanding the pellets on the food product to provide a cooked food product comprising cooked, expanded pellets and a cooked substrate.
   8. The method of any of clauses 1-11, excluding the present clause:
wherein the extruded pellets, before cooking, have a size distribution selected from the group consisting of a size distribution in which at least 99 wt. % of particles pass through a 4.75 mm sized screen and/or at least 99 wt. % of pellets are retained by a 0.074 mm sized screen, a size distribution in which at least 90 wt. % of the pellets are small enough to pass through a 4.75 mm sized screen and/or at least about 90 wt. % of the pellets are large enough to be retained by a 1.40 mm sized screen, a size distribution in which at least 80 wt. % of the pellets are small enough to pass through a 1.70 mm sized screen and/or at least 70 wt. % of the pellets are large enough to be retained by a 0.71 mm sized screen, and a size distribution in which at least 80 wt. % of the pellets are small enough to pass through a 0.60 mm sized screen and/or at least 70 wt. % of the pellets are large enough to be retained by a 0.355 mm sized screen.
   9. The method of any of clauses 1-11, excluding the present clause, further comprising:
cooking the extruded pellets to provide an expanded density at 25° C. that is no more than a density selected from the group consisting of about ½, ⅓, ¼, ⅕, ⅙, 1/7, ⅛, 1/9, and 1/10 of an unexpanded density at 25° C. of the extruded pellets, wherein the cooking occurs for at least about 15 seconds and no more than about 1.5 minutes in about 0.15 to 0.30 meters of canola oil at about 350° F. and about 1 atm pressure at the surface of the canola oil.
   10. The method of any of clauses 1-11, excluding the present clause, wherein the extruded pellets, before cooking, have a density selected from the group consisting of about 100-900 g/L at 25° C., 100-150 g/L at 25° C., 150-220 g/L at 25° C., 220-250 g/L at 25° C., 250-500 g/L at 25° C., 500-900 g/L at 25° C., and 600-900 g/L at 25° C.
   11. The method of any of clauses 1-11, excluding the present clause:
wherein the extruded pellets, after cooking, have a density of about 25-200 g/L at 25° C., 25-30 g/L at 25° C., 30-42 g/L at 25° C., 42-50 g/L at 25° C., 50-60 g/L at 25° C., 60-100 g/L at 25° C., 100-150 g/L at 25° C., and 150-200 g/L at 25° C., wherein the cooking occurs for at least about 15 seconds and no more than about 1.5 minutes in about 0.15 to 0.30 meters of canola oil at about 350° F. and about 1 atm pressure at the surface of the canola oil.
   12. A pellet-coated food product prepared according to any of clauses 1-11.
   13. A frozen, pellet-coated food product comprising:
a substrate comprising an outer surface;
a substrate coating adhered to the outer surface of the substrate;
wherein the substrate coating comprises pellets;
wherein the pellets are unexpanded.
   14. The food product of any of clauses 13-29, excluding the present clause:
wherein the pellets comprise about 10-45 wt. % depolymerized starch.
   15. The food product of any of clauses 13-29, excluding the present clause:
wherein the pellets comprise about 8.5-14.5 wt. % non-covalently bound water.
   16. The food product of any of clauses 13-29, excluding the present clause:
wherein the pellets comprise at least about 60 wt. % of a primary component.
   17. The food product of any of clauses 13-29, excluding the present clause:
wherein the food product is uncooked.
   18. The food product of any of clauses 13-29, excluding the present clause:
wherein the food product is partially cooked.
   19. The food product of any of clauses 13-29, excluding the present clause, further comprising:
breading;
wherein the breading and the pellets are adhered to the outer surface of the food product.
   20. The food product of any of clauses 13-29, excluding the present clause, further comprising:
a supplemental adhesive;
optionally, wherein the supplemental adhesive is selected from a batter, a glaze, and any combination thereof.
   21. The food product of any of clauses 13-29, excluding the present clause:
wherein the food product comprises an adhesive outer surface;
wherein the pellets adhere to the adhesive outer surface of the food product without need for a supplemental adhesive.
   22. The food product of any of clauses 13-29, excluding the present clause:
wherein the pellets are made by extruding, sheeting, pelletizing and forming a feed material selected from the group consisting of animal matter, plant matter, dairy matter, and any combination thereof.
   23. The food product of any of clauses 13-29, excluding the present clause:
wherein the pellets are thin in a first dimension and elongated in at least one other dimension to provide the food product with a texture similar to a chip crumble after the food product is finish cooked.
   24. The food product of any of clauses 13-29, excluding the present clause:
wherein the pellets are shaped and sized so that, after cooking, the pellets approximate a chip crumble in at least one characteristic selected from appearance, texture, and any combination thereof.
   25. The food product of any of clauses 13-29, excluding the present clause:
wherein the pellets provide at least about 5 wt. % of a total mass of the substrate coating.
   26. The food product of any of clauses 13-29, excluding the present clause:
wherein the pellets, before cooking, have a size distribution selected from the group consisting of a size distribution in which at least 99 wt. % of particles pass through a 4.75 mm sized screen and/or at least 99 wt. % of pellets are retained by a 0.074 mm sized screen, a size distribution in which at least 90 wt. % of the pellets are small enough to pass through a 4.75 mm sized screen and/or at least about 90 wt. % of the pellets are large enough to be retained by a 1.40 mm sized screen, a size distribution in which at least 80 wt. % of the pellets are small enough to pass through a 1.70 mm sized screen and/or at least 70 wt. % of the pellets are large enough to be retained by a 0.71 mm sized screen, and a size distribution in which at least 80 wt. % of the pellets are small enough to pass through a 0.60 mm sized screen and/or at least 70 wt. % of the pellets are large enough to be retained by a 0.355 mm sized screen.
   27. The food product of any of clauses 13-29, excluding the present clause:
wherein the pellets expand to provide a density at 25° C. after cooking that is no more than a density selected from the group consisting of about ½, ⅓, ¼, ⅕, ⅙, 1/7, ⅛, 1/9, and 1/10 of an unexpanded density at 25° C. of the extruded pellets, wherein the cooking occurs for at least 15 seconds and no more than about 1.5 minutes in about 0.15 to 0.30 meters of canola oil at about 350° F. and about 1 atm pressure at the surface of the canola oil.
   28. The food product of any of clauses 13-29, excluding the present clause:
wherein the pellets, before cooking, have a density selected from the group consisting of about 100-900 g/L at 25° C., 100-150 g/L at 25° C., 150-220 g/L at 25° C., 220-250 g/L at 25° C., 250-500 g/L at 25° C., 500-900 g/L at 25° C., and 600-900 g/L at 25° C.
   29. The food product of any of clauses 13-29, excluding the present clause:
wherein the pellets, after cooking, have a density of about 25-200 g/L at 25° C., 25-30 g/L at 25° C., 30-42 g/L at 25° C., 42-50 g/L at 25° C., 50-60 g/L at 25° C., 60-100 g/L at 25° C., 100-150 g/L at 25° C., and 150-200 g/L at 25° C., wherein the cooking occurs for at least about 15 seconds and no more than about 1.5 minutes in about 0.15 to 0.30 meters of canola oil at about 350° F. and about 1 atm pressure at the surface of the canola oil.

Although certain embodiments have been described with reference to a particular type of cooking, for example, frying, baking, microwaving, the type of cooking used can be interchanged with another type of cooking, for example, frying, baking, microwaving to form additional embodiments.

Additionally, while this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method comprising the steps:
extruding an extruder feed stream to provide an extrudate;
pelletizing the extrudate to provide extruded pellets;
drying the pellets to provide dried pellets;
providing at least a portion of an outer surface of a substrate with an adhesive to provide an adhesive substrate;
applying at least a portion of the pellets to the outer surface of the substrate to provide a pellet-coated food product comprising the substrate and the pellets; and
freezing the food product.

2. The method of claim 1, further comprising:
hydrating a feed material to provide the extruder feed stream.

3. The method of claim 1, further comprising:
mixing a feed material to provide the extruder feed stream.

4. The method of claim 1, further comprising:
hydrating and mixing a feed material to provide the extruder feed stream.

5. The method of claim 1, further comprising:
flattening the pellets to provide flat pellets.

6. The method of claim 1, further comprising:
forming the pellets to provide formed pellets with desired sizes.

7. The method of claim 1, further comprising:
cooking the food product to provide a cooked food product, optionally thereby expanding the pellets on the food product to provide a cooked food product comprising cooked, expanded pellets and a cooked substrate.

8. The method of claim 1:
wherein the extruded pellets, before cooking, have a size distribution selected from the group consisting of a size distribution in which at least 99 wt. % of particles pass through a 4.75 mm sized screen and at least 99 wt. % of pellets are retained by a 0.074 mm sized screen, a size distribution in which at least 90 wt. % of the pellets are small enough to pass through a 4.75 mm sized screen and at least about 90 wt. % of the pellets are large enough to be retained by a 1.40 mm sized screen, a size distribution in which at least 80 wt. % of the pellets are small enough to pass through a 1.70 mm sized screen and at least 70 wt. % of the pellets are large enough to be retained by a 0.71 mm sized screen, and a size distribution in which at least 80 wt. % of the pellets are small enough to pass through a 0.60 mm sized screen and at least 70 wt. % of the pellets are large enough to be retained by a 0.355 mm sized screen.

9. The method of claim 1, further comprising:
cooking the extruded pellets to provide an expanded density at 25° C. that is no more than about ½ of an unexpanded density at 25° C. of the extruded pellets, wherein the cooking occurs for at least about 15 seconds and no more than about 1.5 minutes in about 0.15 to 0.30 meters of canola oil at about 350° F. and about 1 atm pressure at the surface of the canola oil.

10. The method of claim 1, wherein the extruded pellets, before cooking, have a density selected from the group consisting of about 100-900 g/L at 25° C., 100-150 g/L at 25° C., 150-220 g/L at 25° C., 220-250 g/L at 25° C., 250-500 g/L at 25° C., 500-900 g/L at 25° C., and 600-900 g/L at 25° C.

11. The method of claim 1:
wherein the extruded pellets, after cooking, have a density of about 25-200 g/L at 25° C., 25-30 g/L at 25° C., 30-42 g/L at 25° C., 42-50 g/L at 25° C., 50-60 g/L at 25° C., 60-100 g/L at 25° C., 100-150 g/L at 25° C., and 150-200 g/L at 25° C., wherein the cooking occurs for at least about 15 seconds and no more than about 1.5 minutes in about 0.15 to 0.30 meters of canola oil at about 350° F. and about 1 atm pressure at the surface of the canola oil.

12. A pellet-coated food product prepared according to claim 1.

13. A frozen, pellet-coated food product comprising:
a substrate comprising an outer surface;
a substrate coating adhered to the outer surface of the substrate;
wherein the substrate coating comprises pellets;
wherein the pellets are unexpanded.

14. The food product of claim 13:
wherein the pellets comprise about 10-45 wt. % depolymerized starch.

15. The food product of claim 13:
wherein the pellets comprise about 8.5-14.5 wt. % non-covalently bound water.

16. The food product of claim 13:
wherein the pellets comprise at least about 60 wt. % of a primary component.

17. The food product of claim 13:
wherein the food product is uncooked.

18. The food product of claim 13:
wherein the food product is partially cooked.

19. The food product of claim 13, further comprising:
breading;
wherein the breading and the pellets are adhered to the outer surface of the food product.

20. The food product of claim 13, further comprising:
a supplemental adhesive;
optionally, wherein the supplemental adhesive is selected from a batter, a glaze, and any combination thereof.

21. The food product of claim 13:
wherein the food product comprises an adhesive outer surface;
wherein the pellets adhere to the adhesive outer surface of the food product without need for a supplemental adhesive.

22. The food product of claim 13:
wherein the pellets are made by extruding, sheeting, pelletizing and forming a feed material selected from the group consisting of animal matter, plant matter, dairy matter, and any combination thereof.

23. The food product of claim 13:
wherein the pellets are thin in a first dimension and elongated in at least one other dimension to provide the food product with a texture similar to a chip crumble after the food product is finish cooked.

24. The food product of claim 13:
wherein the pellets are shaped and sized so that, after cooking, the pellets approximate a chip crumble in at least one characteristic selected from appearance, texture, and any combination thereof.

25. The food product of claim 13:
wherein the pellets provide at least about 5 wt. % of a total mass of the substrate coating.

26. The food product of claim 13:
wherein the pellets, before cooking, have a size distribution selected from the group consisting of a size distribution in which at least 99 wt. % of particles pass through a 4.75 mm sized screen and at least 99 wt. % of pellets are retained by a 0.074 mm sized screen, a size distribution in which at least 90 wt. % of the pellets are small enough to pass through a 4.75 mm sized screen and at least about 90 wt. % of the pellets are large enough to be retained by a 1.40 mm sized screen, a size distribution in which at least 80 wt. % of the pellets are small enough to pass through a 1.70 mm sized screen and at least 70 wt. % of the pellets are large enough to be retained by a 0.71 mm sized screen, and a size distribution in which at least 80 wt. % of the pellets are small enough to pass through a 0.60 mm sized screen and at least 70 wt. % of the pellets are large enough to be retained by a 0.355 mm sized screen.

27. The food product of claim 13:
wherein the pellets expand to provide a density at 25° C. after cooking that is no more than about ½ of an unexpanded density at 25° C. of the extruded pellets, wherein the cooking occurs for at least 15 seconds and no more than about 1.5 minutes in about 0.15 to 0.30 meters of canola oil at about 350° F. and about 1 atm pressure at the surface of the canola oil.

28. The food product of claim 13:
wherein the pellets, before cooking, have a density selected from the group consisting of about 100-900 g/L at 25° C.

29. The food product of claim 13:
wherein the pellets, after cooking, have a density of about 25-200 g/L at 25° C., wherein the cooking occurs for at least about 15 seconds and no more than about 1.5 minutes in about 0.15 to 0.30 meters of canola oil at about 350° F. and about 1 atm pressure at the surface of the canola oil.
